(19) United States
(12) Patent Application Publication
(10) Pub. No.: US 2007/0088615 A1
(43) Pub. Date: Apr. 19, 2007

(54) System and method for network-based management of physical and online stores utilizing dual-interfaces general-purpose computers

(76) Inventor: Yu Meng, Bronx, NY (US)

Correspondence Address: Yu Meng, 3512 Oxford Ave, #3D, Bronx, NY, 10463, US

(21) Appl. No.: 11/242,380

(22) Filed: Oct. 3, 2005

(51) Int. Cl. G06Q 30/00

(52) U.S. Cl. 705/26

(57) ABSTRACT

The system and method of the invention can provide a system and method that manage both an online store and physical stores utilizing dual-interfaces general-purpose computers. The present invention utilizes a centralized database for managing both an online store and physical stores. The management functionalities for the online store and the physical stores are integrated into one system. In order to utilize the benefits of both a general-purpose computer interface and a POS-style interface, and avoid their disadvantages at the same time, dual interfaces are used in the present invention. A POS-style interface is used to perform easy daily operations, while a general-purpose computer interface is used to perform complicated management tasks and other general-purpose computer tasks.

### BACKGROUND OF THE INVENTION

Store management systems handle a variety of different functions, ranging from Electronic Point of Sale (EPOS) and customer information to back-end inventory and labor management.

The store-management system is a collection of software products that helps to keep all aspects of the store business running smoothly. Think of it as a two-part system, with one part managing the back of the house and the other part managing the front of the house.

The front-of-house system can sometimes be a facility separate from the store POS, but in some cases the POS software will include many front-of-house features as part of the core product. The back-of-house system runs the elements of the store that the customers do not see directly. This part of the operation helps the managers maintain an adequate inventory and keep goods flowing properly to customers. It also ensures that enough staff members are available to cover each shift.

Several features of the back-of-house system are staff management, stock control, funds management, and reporting.

POS is an acronym for Point of Sale. POS software enables an efficient and automated recording of the data that comprise a business transaction when the goods or services are sold to customers.

POS systems evolved from the mechanical cash registers of the first half of the 20th century. Examples of this type of register are the NCR registers operated by a crank and the Burroughs registers which were operated by a lever. These registers recorded data on journal tapes or paper tape and required an extra step to transcribe the information into the retailer's accounting system. The next step in the evolution of cash register was operation by electricity. An example of this type of register is the NCR class five cash registers. In 1973 new registers that were driven by computers were introduced, among them the IBM 3653 Store System and the NCR 2150. Other computer-based manufacturers were Regitel, TRW, and Datachecker. The year 1973 also saw the introduction of the UPC/EAN barcode readers on POS systems. In 1986, with the introduction of the IBM 4683, POS systems began to be based on PC technology. By 2005 retail POS systems were among the most sophisticated and powerful computer networks in commercial use.

POS software often feeds data to other software modules to create a more comprehensive and useful array of software tools, including merchandising, forecasting, accounting, and inventory-control. In some POS software packages, these functions are fully integrated.

In 1985 Mosher introduced the first touch-screen-driven, color-graphic, POS-style interface. This software ran on the Atari ST, the world's first consumer-level color-graphic computer. By the end of the 20th century, Mosher's promotion of his unpatented software paradigm had resulted in its worldwide adoption by cash-register manufacturers and other POS-software developers as the de facto standard for point-of-sale software systems.

POS systems have two big problems.

First, POS systems cannot perform many computing tasks the way general-purpose computers can.

Unlike general-purpose computers, POS systems usually have large buttons in the interface. This is because most operators are not familiar with computer operations, and they need only limited functionalities for daily operations. Because of those large buttons, the interface cannot display nearly as much information as the interface on general-purpose computers. On the other hand, store managers need more functionalities to manage their stores. Sometimes, their staff members need or want more than only the ability to take orders; they also want to do other computer tasks, like surfing the Internet to find useful information about their businesses and news about their industry. If all functionalities were added to a POS system, too many steps would be required to access each function, increasing the possibility of users' confusion and consuming unacceptable amounts of time. Thus, with one interface pattern, it is very difficult to satisfy staff members who need simple functionalities with a simple interface and also satisfy managers who need rich functionalities with a complicated interface.

Secondly, POS systems face difficulties with integration of different systems.

Many stores utilize management systems inside the stores. They also have online stores to enable customers to order their products. But the in-house systems and the online systems are not integrated. Integrating the two systems utilizing POS systems is a tedious job.

Ranganath, et al., U.S. patent application Ser. No. 09/827,725, entitled “Point of sale device, e-commerce system, and method and apparatus for order processing and inventory management,” shows a method comprising: providing a point-of-sale device including a processor, a printer coupled to the processor, a display coupled to the processor, a keypad coupled to the processor, and a communications interface coupled to the processor; defining a retailer web site using an e-commerce server such that a consumer can access the retailer web site by connecting to the e-commerce server via a client machine and can place orders for merchandise; and receiving orders using an application server from the e-commerce server and communicating with the point-of-sale device to transmit orders to the point-of-sale device. Their system provides a retail point-of-sale device, which is coupled to an Internet e-commerce shop server through an application server. Because their method requires an application server in order to access an e-commerce server, it is complicated to set up the system. The method utilizes two databases, one for a POS device and one for an e-commerce server. The two databases need to be synchronized from time to time in order to make them consistent. In addition, because the system uses a POS device to access the Internet, there are a lot of limitations that prevent the full utilization of the features of Internet resources. It is impossible to use the POS device to perform other computer tasks, as a general-purpose computer does.

Cusack, et al., U.S. patent application Ser. No. 10/734,200, entitled “System and method for facilitating real-time, web based point of sale (POS) transactions and operations,” shows a system and method for facilitating real-time, web-based point-of-sale operations such as sales, reporting, etc. The system and method include and involve a central database facility storing and maintaining data relating to items to be sold at a point of sale and at least one user interface.

Their system takes advantage of secure database techniques, relational database practices and paradigms, etc., to allow possibly multiple and disparate enterprises to share resources to engage in real-time web-enabled e-commerce like POS transactions.

Their system does not integrate online store management, but only considers store employees taking orders at POS terminals. They do not consider integrating other store-management functionalities into their system, either. Their system permits “back-office” operations such as management-reporting operations (e.g., queries related to sales of particular items and groups of items, inventory reports, etc.) to be done via a web interface. Their system can only manage orders and order-related inventories from POS terminals. Their system cannot manage other tasks, such as labor management in the physical store, salary management, funds management, etc. Because they do not use general-purpose computers as their POS devices, it is difficult to integrate other store-management functionalities into their system. It is impossible to perform other computer tasks with their POS devices as the way general-purpose computers do.

Many types of store-management and inventory-control systems exist today. Each of these systems views the process from the narrow viewpoint of the goals of such a system. For example, store-management processes tend to manage the orders, inventory, and back-office in the physical store. The store-management process does not generally take into account the orders placed through the online store. On the other hand, the online ordering process manages the online orders and notifies the store but does not communicate with the management system in the physical store. What is needed is a system that will help managers with each of these viewpoints in understanding the effect of the various decisions regarding the orders and store management as a whole, both currently and into the near future.

Many stores have struggled for many years with multiple separate management systems, because they have to maintain a traditional POS in-store management system and take orders from an online-store system on the Internet at the same time. Some stores receive orders through facsimiles; other stores retrieve orders through the Internet. No matter how the stores get Internet orders, the online system is not integrated with the in-store POS system. Workers have to re-input the Internet orders into the in-store POS system in order to start the process in the physical store.

Many stores have another problem. Traditional POS devices are specially designed for the checkout and payment processes. They are easy to use if store workers use them only for payment processing. If workers want to use the POS devices to manage the stores, or to perform other general-purpose computer tasks, such as accessing web servers or surfing the Internet, POS devices do not serve the purposes well. Many companies have attempted to use POS devices to perform general-purpose computer tasks. Integrating the two systems is a tedious job that consumes a lot of time and manpower; moreover, the integrated system has only limited features and also contains a lot of problems.

The present invention provides a management system and method which integrate the management of both an online store and physical stores. Because the management system has dual interfaces—POS-style interface and general-purpose computer interface—it provides the benefits of both traditional POS devices and general-purpose computers.

### BRIEF SUMMARY OF THE INVENTION

It is an object of the invention to utilize general-purpose computers as POS devices.

It is another object of the invention to provide easy-to-use interfaces for simple daily operations, complicated store-management tasks, and general-purpose computer tasks.

It is still another object of the invention to integrate the management of physical stores and an online store, and to manage traditional phone orders and walk-in orders as well as online orders.

There are dual interfaces for the system: the general-purpose computer interface and the traditional POS-style interface.

The general-purpose computer interface is designed for managers to finish complicated tasks.

The POS-style interface is designed for managers and staff to do simple daily tasks, such as processing orders and receiving payments.

Because the server of the system is located at the network, it is very useful for chain stores. The owners or managers of the chain stores can manage multiple stores through accessing the centralized database on the network.

By using different interfaces for different purposes, store managers and staff can perform complicated jobs as well as simple tasks easily and efficiently.

Briefly, the present invention relates to a management system and method for managing both an online store and physical stores.

General-purpose computers are utilized to perform both general-purpose computer tasks and POS-device tasks. General-Purpose Computer Interface and POS-Style Interface are provided with the general-purpose computers. The dual interfaces are associated with general-purpose computer tasks and POS-device tasks, respectively.

In general, the present invention provides a management system and method for managing both an online store and physical stores. It has the benefits of both general-purpose computers and POS devices.

The above and other objects and advantages of the invention will become more readily apparent when reference is made to the descriptions in conjunction with the accompanying drawings.

### BRIEF DESCRIPTION OF THE DRAWINGS

FIG. 1 is a diagram illustrating the location of the management system of the present invention in a typical system for the Internet.

FIG. 2 is a block diagram of the Internet server in the management system shown in FIG. 1.

FIG. 3 is a block diagram of the store computer in the management system shown in FIG. 1.

FIG. 4 is a block diagram of the general-purpose computer interface in the store computer shown in FIG. 1.

FIG. 5 shows a graphical interface of an example of a POS-style interface that shows the main menu of functionalities.

FIG. 6 shows a graphical interface of an example of a general-purpose computer that shows the administrator page of the management system.

FIG. 7 is a flow chart illustrating an example of the operations of the management system when a new order is accepted.

### DETAILED DESCRIPTION OF THE INVENTION

Glossary of Terminology

POS

POS or PoS is an acronym for Point of Sale (or point of purchase). This can mean a retail shop, a checkout counter in a shop, or a variable location where transactions occur.

Point-of-Sale Terminal

A Point-of-Sale (POS) Terminal is a computerized replacement for a cash register. Much more complex than the cash registers of even just a few years ago, the POS system can include the ability to record and track customer orders, process payments by credit and debit cards, connect to other systems in a network, and manage inventory. Generally, a POS terminal has as its core a personal computer, which is provided with application-specific programs and I/O devices for the particular environment in which it will serve. A POS system for a restaurant, for example, is likely to have all menu items stored in a database that can be queried for information in a number of ways. POS terminals are used in most industries that have a point of sale such as a service desk, including restaurants, lodging, entertainment, and museums.

POS-Style Interface

A Point-of-Sale (POS) Terminal usually provides a simple interface so operators without computer experience can use it easily. Usually, a POS terminal has a simple interface with large buttons on a touchable screen, so that operators do not have to use a keyboard or mouse. Hence, a POS Terminal usually has very limited functionalities. “POS-Style Interface” in the present invention indicates a simple interface similar to those of most POS terminals with limited functionalities.

General-Purpose Computer

A computer designed to perform, or that is capable of performing, in a reasonably efficient manner, the functions required by both scientific and business applications.

General-Purpose Computer Interface

A graphical user interface for general-purpose computers; uses a mouse as well as a keyboard as an input device.

Examples of systems with a general-purpose computer interface are Mac OS, Microsoft Windows, NEXTSTEP and the X Window System.

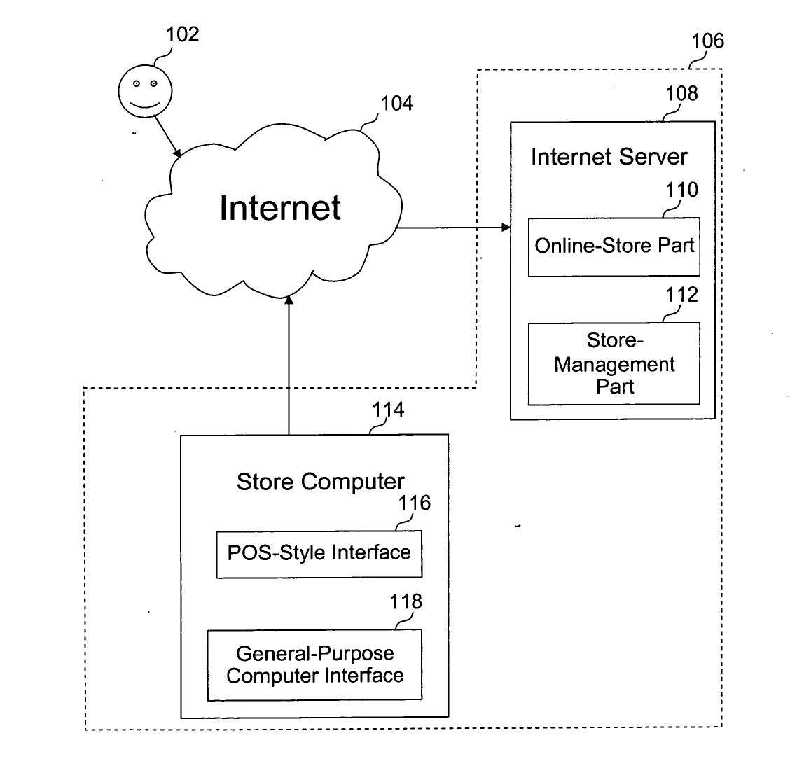

In the drawings, FIG. 1 is a diagram illustrating the location of the management system of the present invention in a typical system for the Internet.

The management system of the present invention is shown in block 106. The customers 102 access the management system 106 through the Internet 104.

In the management system 106, there is an Internet Server 108 which has Online-Store Part 110 and Store-Management Part 112; there is also a Store Computer 114 which has both POS-Style Interface 116 and General-Purpose Computer Interface 118.

The managers and staff in the store access Internet Server 108 through Internet 104 with Store Computer 114.

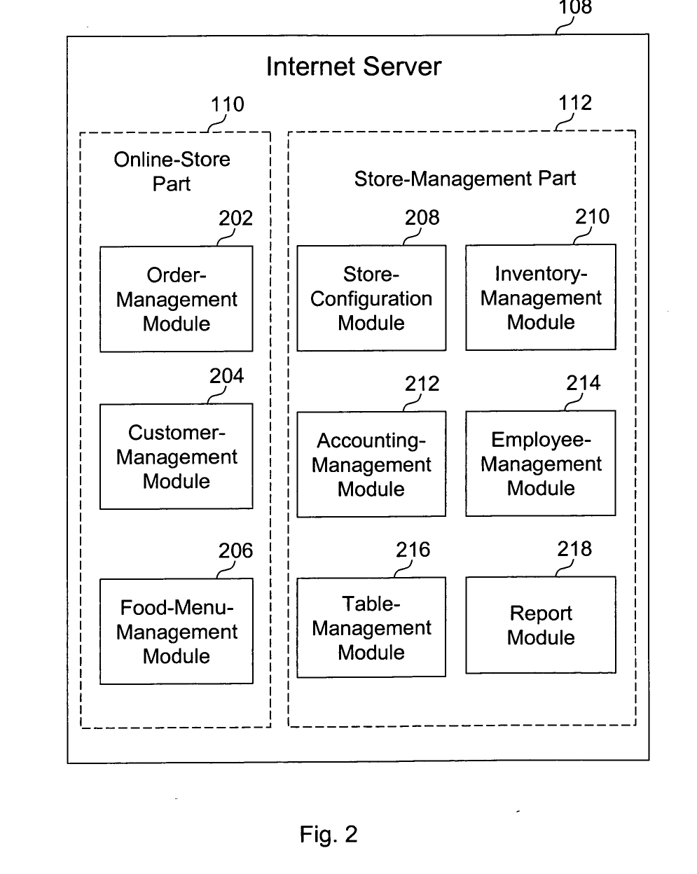

FIG. 2 is a block diagram of the Internet server in the management system shown in FIG. 1.

The Online-Store Part 110 is used to handle online ordering on the Internet. It contains Order-Management Module 202, Customer-Management Module 204, and Food-Menu-Management Module 206.

The Store-Management Part 112 is used to manage the store operations. It contains Store-Configuration Module 208, Inventory-Management Module 210, Accounting-Management Module 212, Employee-Management Module 214, Table-Management Module 216, and Report Module 218.

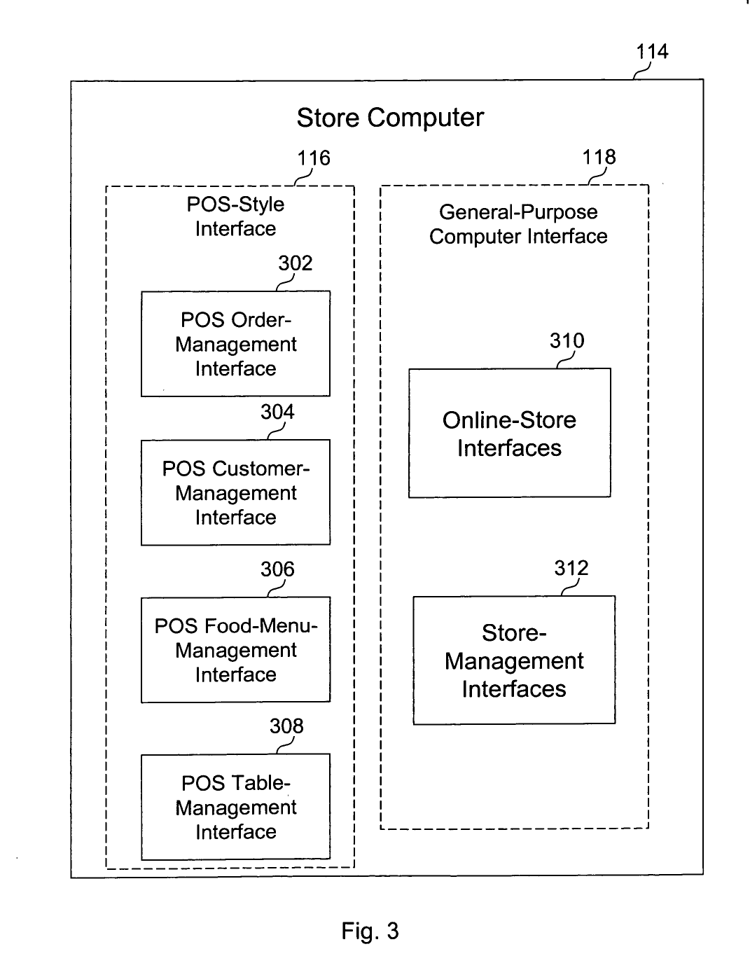

FIG. 3 is a block diagram of the Store Computer in the management system shown in FIG. 1.

The Store Computer 114 has two interfaces. One is POS-Style Interface 116, which is used to accomplish simple daily tasks, and the other one is General-Purpose Computer Interface 118, which is used to do complicated and general-purpose computer tasks.

The POS-Style Interface 116 contains POS-Order Management Interface 302, POS Customer-Management Interface 304, POS Food-Menu-Management Interface 306, and POS Table-Management Interface 308.

The General-Purpose Computer Interface 118 contains Online-Store Interfaces 310, which are used to handle online ordering, and Store Management Interfaces, which are used to manage other store operations.

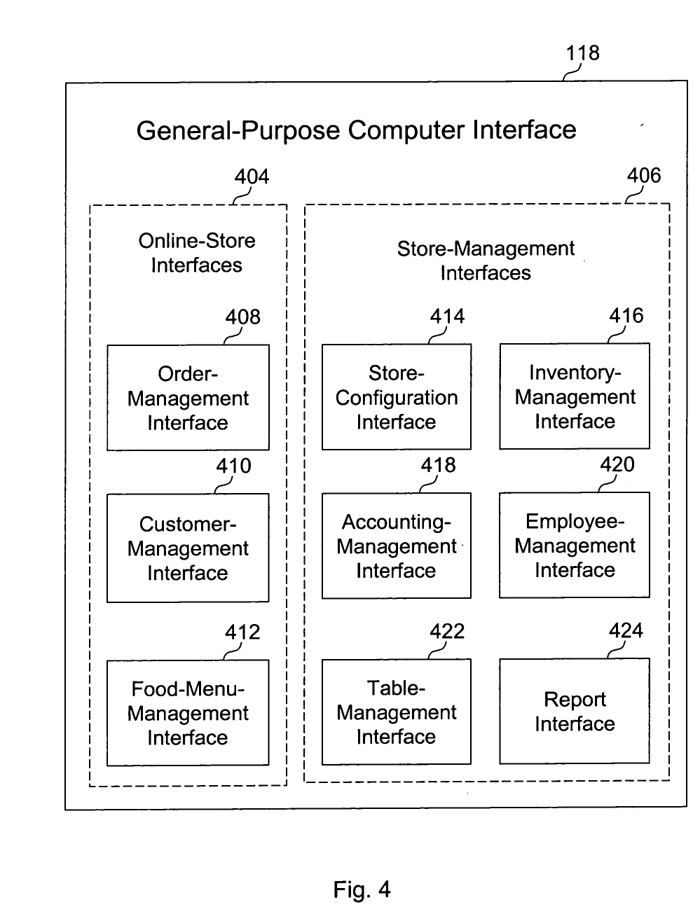

FIG. 4 is a block diagram of the general-purpose computer interface in the store computer shown in FIG. 1.

General-Purpose Computer Interface 118 is used to accomplish complicated tasks. It would most likely be used primarily by store managers.

General-Purpose Computer Interface 118 contains Online-Store Interfaces 404 and Store-Management Interfaces 406, which will communicate with Online-Store Part 110 and Store-Management Part 112, respectively.

Order-Management Interface 408, Customer-Management Interface 410, and Food-Menu-Management Interface 412 constitute Online-store Interfaces 404.

Store-Management Interfaces 406 contains Store-Configuration Interface 414, Inventory-Management Interface 416, Accounting-Management Interface 418, Employee-Management Interface 420, Table-Management Interface 422, and Report Interface 424.

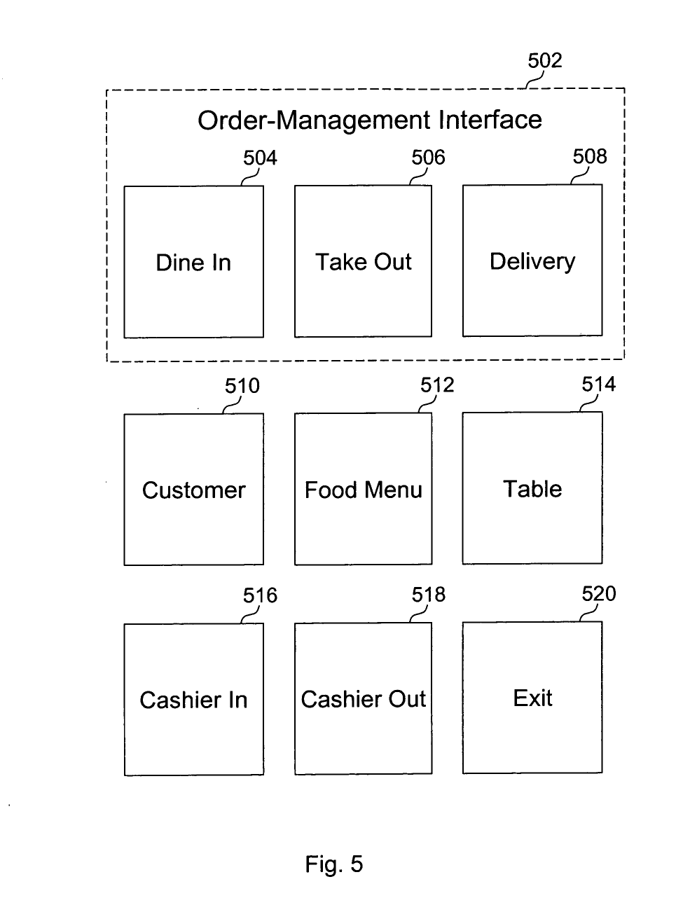

FIG. 5 shows a graphical interface of an example of a POS-style interface that shows the main menu of functionalities.

The POS-style interface is used to accomplish simple daily operations. It is usually used by store staff for frequently used and limited functionalities.

On the POS-style interface, Order-Management Interface 502 contains Dine In 504 button, Take Out 506 button, and Delivery 508 button, which correspond to the customers' order requests.

Customer 510 button is used to manage customers, by means of customers' addresses, statuses, etc. Food Menu 512 button is used to maintain the food menu, by means of name of the food or drink, information about price, etc.

Table 514 button is used to maintain tables in the physical store, including information about whether they are occupied, whether they have been cleaned, etc.

Cashier In 516 button and Cashier Out 518 button are used to let cashiers log in and log out. Exit 520 button will close the interface.

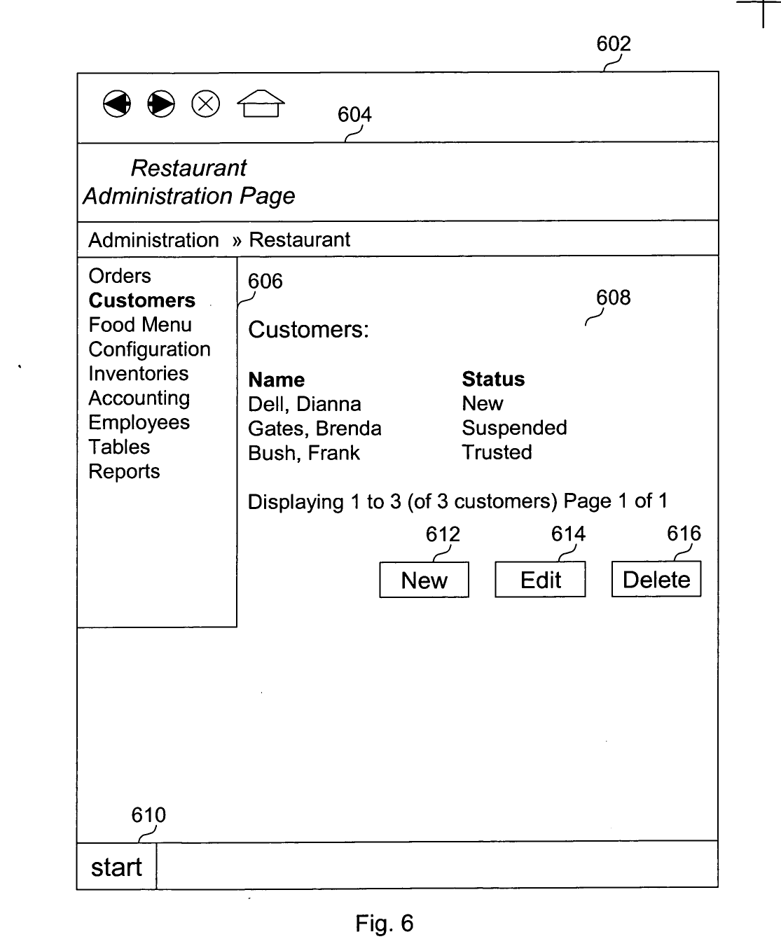

FIG. 6 shows a graphical interface of an example of a general-purpose computer that shows the administrator page of the management system.

A typical screen of General-Purpose Computer Interface 118 is shown in block 602.

In this example, a computer running Microsoft Windows with a “start” icon in block 610 is shown. On the screen, the page title “Restaurant Administration Page” is shown in block 604.

In block 606, there is a list of functionalities related to the management of both the online and the physical stores. In this example, the functionality “Customers” is selected, which means that the computer operator is working with customer management.

To the right of block 606, detailed information about management is displayed in block 608. In this example, a list of customers is shown with their names and statuses as customers.

Staff can add information about a new customer by pressing New 612 button, or change a customer's information by pressing Edit 614 button. With Delete 616 button, staff can delete the name of and information about an existing customer.

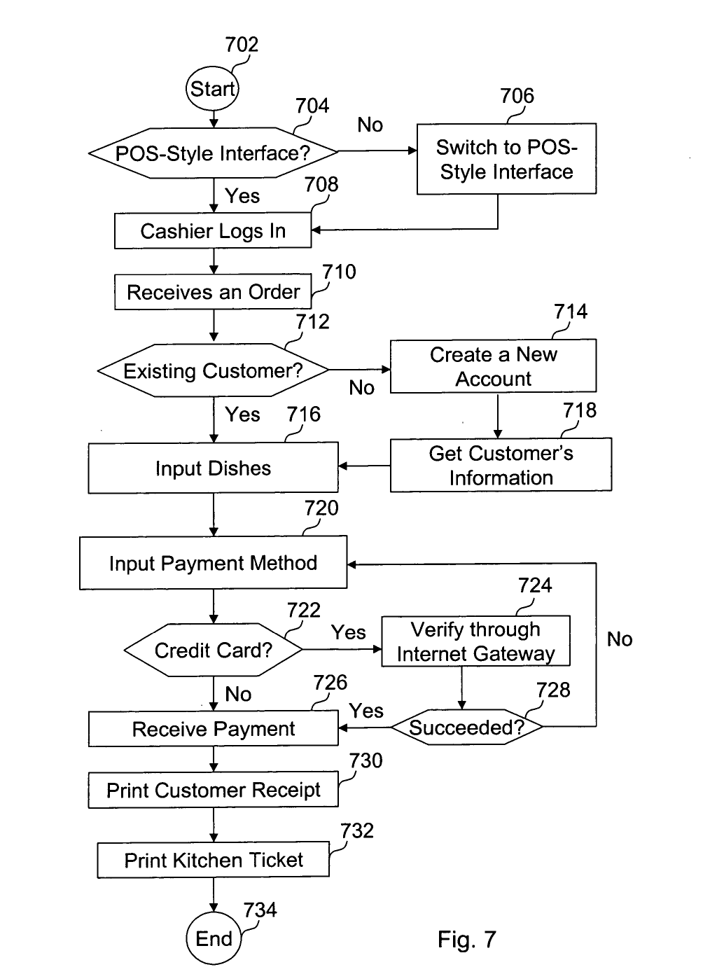

FIG. 7 is a flow chart illustrating an example of the operations of the management system when a new order is accepted.

The process starts at block 702. The decision block 704 determines if the system is in POS-style interface mode. If the system is not in POS-style interface mode, the cashier needs to switch to POS-style interface, in block 706.

The cashier logs in at block 708 and the system receives an order in block 710.

The decision block 712 determines if the order came from an existing customer. If the order came from a new customer, the system will create a new account at block 714 and get the customer's information at block 718. The cashier inputs choices for the order at block 716 and inputs the payment method in block 720.

If the customer pays with a credit card, in block 722, the credit card will be verified through the Internet gateway at block 724. If the credit-card verification fails, at block 728, the system will ask for another payment method, in block 720. The system will receive payment at block 726 and print the customer's receipt at block 730. The ticket with order information for cooks and other kitchen workers will be printed at block 732. The process will end at end block 734.

Advantages

From the description above, a number of advantages of the present invention become evident:

(a) A general-purpose computer has many more functionalities than a POS device, but its operation requires computer knowledge and experience. POS devices usually have a user-friendly interface, but they have fewer functionalities. The present invention provides both a POS-style interface and a general-purpose computer interface.

(b) With its two interfaces, the present system can perform complicated computer tasks as well as simple POS tasks easily and efficiently.

(c) Because the Internet server can be accessed from any place that has Internet access, the present invention is very useful for chain stores for generating reports and statistics regarding sales.

(d) The present invention integrates the management systems of traditional stores and an online store for multiple stores located in different physical locations. It can manage traditional phone orders and walk-in orders as well as online orders.

### CONCLUSION AND SCOPE

Accordingly, readers can see that the present invention can manage an online store as well as physical stores with a centralized management database on the network. The present invention combines the benefits of general-purpose computers and POS devices to perform different tasks.

When store staff members perform simple daily operations, they can use the POS-style interface. When the staff or managers perform complicated management or general-purpose computer tasks, they can use the general-purpose computer interface.

Although the present invention has been described in detail, it will be understood that this description is not intended to limit the invention to this embodiment. Instead, it is intended to cover all alternatives, modifications, and equivalents as may be included within the spirit and scope of the present invention as defined by the appended claims.

I claim:

1. A network-based management system for managing both physical and online stores, comprising:
an Internet server; and
general-purpose computers with dual interfaces located in the physical stores; and
means for accessing the Internet server from said general-purpose computer located in each physical store.

2. The management system as set forth in claim 1 wherein said Internet server comprises:
online-store part; and
store-management part.

3. The management system as set forth in claim 1 wherein said dual interfaces comprises:
POS-style interface; and
General-purpose computer interface.

4. The Internet server as set forth in claim 2 wherein said online-store part comprises:
order-management module; and
food-menu-management module.

5. The Internet server as set forth in claim 2 wherein said store-management part contains modules selected from the group consisting of:
store-configuration module,
inventory-management module,
accounting-management module,
employee-management module,
table-management module,
report module.

6. The dual interfaces as set forth in claim 3 wherein said POS-style interface comprises:
POS order-management interface, which contacts with said order-management module; and
POS food-menu-management interface, which contacts with said food-menu-management module.

7. The dual interfaces as set forth in claim 3 wherein said general-purpose computer interface contains interfaces selected from the group consisting of:
store-configuration interface, which communicates with store-configuration module,
inventory-management interface, which communicates with inventory-management module,
accounting-management interface, which communicates with accounting-management module,
employee-management interface, which communicates with employee-management module,
table-management interface, which communicates with table-management module,
report interface, which communicates with report module.

8. A network-based management method for managing both physical and online stores, comprising the steps of:
providing store services from an Internet server; and
utilizing general-purpose computers with dual interfaces located in the physical stores; and
accessing the Internet server from said general-purpose computer located in each physical store.

9. The management method as set forth in claim 8 wherein said store services comprises:
online-store service; and
store-management service.

10. The management method as set forth in claim 8 wherein said utilizing general-purpose computers with dual interfaces comprises:
utilizing POS-style interface; and
utilizing general-purpose computer interface.

11. The store services as set forth in claim 9 wherein said online-store service comprises:
means for managing orders;
means for managing food menus.

12. The store services as set forth in claim 9 wherein said store-management service contains means selected from the group consisting of:
means for configuring the store,
means for managing inventories,
means for managing accounting,
means for managing employees,
means for managing tables,
means for generating reports.

13. The dual interfaces as set forth in claim 10 wherein said utilizing POS-style interface comprises:
utilizing POS order-management interface, which communicates with said order-management module; and
utilizing POS food-menu-management interface, which communicates with said food-menu management module.

14. The dual interfaces as set forth in claim 10 wherein said utilizing general-purpose computer interface contains means selected from the group consisting of:
utilizing store-configuration interface, which communicates with store-configuration module,
utilizing inventory-management interface, which communicates with inventory-management module,
utilizing accounting-management interface, which communicates with accounting-management module,
utilizing employee-management interface, which communicates with employee-management module,
utilizing table-management interface, which communicates with table-management module,
utilizing report interface, which communicates with report module.
